(19) United States
(12) Patent Application Publication
(10) Pub. No.: US 2005/0202700 A1
(43) Pub. Date: Sep. 15, 2005

(54) Door device for opening and closing memory card slot of image photographing apparatus

(75) Inventor: Nam-il Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/047,624

(22) Filed: Feb. 2, 2005

(30) Foreign Application Priority Data
Mar. 10, 2004 (KR) 2004-16015

(51) Int. Cl. H01R 13/44

(52) U.S. Cl. 439/137

(57) ABSTRACT

A door device to open and close a memory card slot of an image photographing apparatus has a door rotatably disposed at an entrance of the memory card slot to open and close the slot. The door is elastically biased in the direction of closing the slot entrance. The door has at least one friction pad for holding the memory card of the slot by friction force. Therefore, friction force is applied by friction pads of the door to a memory card inserted in the slot such that the memory card may be prevented from moving out of the normal position during use.

### CROSS-REFERENCE TO RELATED APPLICATIONS

This application claims the benefit under 35 U.SC. § 119(a) of Korean Patent Application No. 2004-016015 filed on Mar. 10, 2004, in the Korean Intellectual Property Office, the entire disclosure of which is hereby incorporated by reference.

### BACKGROUND OF THE INVENTION

1. Field of the Invention

The present invention relates to an image photographing apparatus recording and reproducing information, such as image and sound information, through the use of a recording medium. More particularly the present invention relates to a door device for opening and closing a memory card slot that is disposed at a main body of an image photographing apparatus.

2. Description of the Related Art

Compactness, high-capacity and multimedia features have been rapidly developed in the electronics and information product market. For example, products such as notebooks (NB's), computer peripheral devices, personal data assistants (PDA's), web pads or tablets, digital cameras and digital camcorders are getting smaller, while having increased data storage capability.

Recording media of diverse types of memory cards are known, such as MS (Memory Stick) cards, SD (Secure Digital) cards, CF (Compact Flash) cards, MMC (Multi-Media Cards) and SM (Smart Media) cards. These cards have small volumes and consume less electric power, while providing the additional advantages of better data keeping quality, data transmission rates, reusability, dust proofness and damp proofness.

A recent image photographing apparatus, such as a digital camcorder, not only photographs moving images but also functions as a still camera to photograph and record still images. A moving image is a magnetic signal and is recorded to a magnetic tape, and a still image is a PCM digital signal and is recorded to the aforementioned diverse kinds of memory cards. If the still image is recorded to a memory card, the recorded image information may be electronically retrieved, and therefore, the image information may be processed by any suitable application.

To use the various kinds of memory cards as an assistant recording media, an image photographing apparatus has a slot in which a memory card may be removably received and a multi-card socket for data processing of the memory card inserted in the slot.

A hinged door is disposed at an entrance of the slot, and the door is elastically biased in the direction of closing the slot entrance by an appropriate device, such as a spring. Therefore, when a memory card is not used, the door closes the slot, such that external substances, such as dust, are substantially prevented from entering the slot. With the mounting of a memory card in the slot, the door is inwardly rotated by outer force and, therefore, the slot is opened.

The general image photographing apparatus as described above holds a memory card in the slot only by the multi-card socket, and therefore, mounting may be so unsteady that the memory card may be separated during use. As a tendency to use memory cards of varying thicknesses and widths with a single multi-card socket increases, the reliability of mounting and dismounting the card is decreased, and the memory card frequently deviates from a normal position during use.

If a memory card is separated from a slot when in use in the image photographing apparatus, an error may occur in recording image information, and therefore, a need exists to prevent a memory card from deviating from the normal position during use.

### SUMMARY OF THE INVENTION

An aspect of the present invention is to provide a door device to open and close a memory card slot of an image photographing apparatus, which holds a memory card in the slot to prevent the memory card from moving out of the normal position during use.

Another aspect of the present invention is to provide a door device for opening and closing a memory card slot of an image photographing apparatus wherein the door holding a memory card is applicable to any kind of memory card irrespective of the thickness and width of the memory card.

A door device to open and close the memory card slot of an image photographing apparatus has a door rotatably disposed at an entrance of the memory card slot to open and close the slot. The door is elastically biased in the direction of closing the slot entrance. The door has at least one friction pad to hold the memory card of the slot by friction force.

According to an embodiment of the present invention, a door device to open and close a memory card slot of an image photographing apparatus has a pair of friction pads formed at the door and spaced by a predetermined distance.

Frictional force by the friction pad of the door is applied to the memory card of the slot in addition to the engaging force of the multi-card socket, and therefore, the memory card is stably mounted such that the memory card is not easily separated from the slot.

According to another embodiment of the present invention, a door device to open and close the memory card slot of an image photographing apparatus has a pair of first friction pads having a height formed at the door and spaced by a predetermined distance. A pair of second friction pads have a larger height than the first friction pads and are disposed at a distance from the first friction pads. The first friction pads are positioned between the second friction pads.

If a thick and narrow memory card is used, such as an MS card, friction force by the first friction pads is applied to the memory card. If a thin and wide memory card is used, such as an SD card, friction force by the second friction pads is applied to the memory card. Therefore, all the memory cards may be prevented from moving out of the normal position during use, irrespective of the sizes of the memory cards.

The friction pads may be integrally formed with the door. Preferably, the material of the friction pads is a high-frictional material, such as rubber, but the material is not so limited as any suitable material may be used.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above and other aspects, features and advantages of the present invention will be more apparent from the following detailed description taken with reference to the accompanying drawings, in which:

FIG. 1 is a perspective view of an image photographing apparatus having a door device for opening and closing a memory card slot according to an embodiment of the present invention;

FIG. 2 is an exploded perspective view in partial cross section of a door device for opening and closing a memory card slot of the image photographing apparatus of FIG. 1; and

FIG. 3 is a perspective view of a door having first and second pairs of friction pads.

Throughout the drawings, like reference numerals will be understood to refer to like parts, components and structures.

### DETAILED DESCRIPTION OF EXEMPLARY EMBODIMENTS

Exemplary embodiments of the present invention will be described in greater detail with reference to the accompanying drawings.

The matters defined in the description, such as a detailed construction and elements thereof, are provided to assist in a comprehensive understanding of the invention. Thus, it is apparent that exemplary embodiments of the present invention may be carried out without those defined matters. Also, descriptions of well-known functions or constructions are omitted for conciseness and clarity.

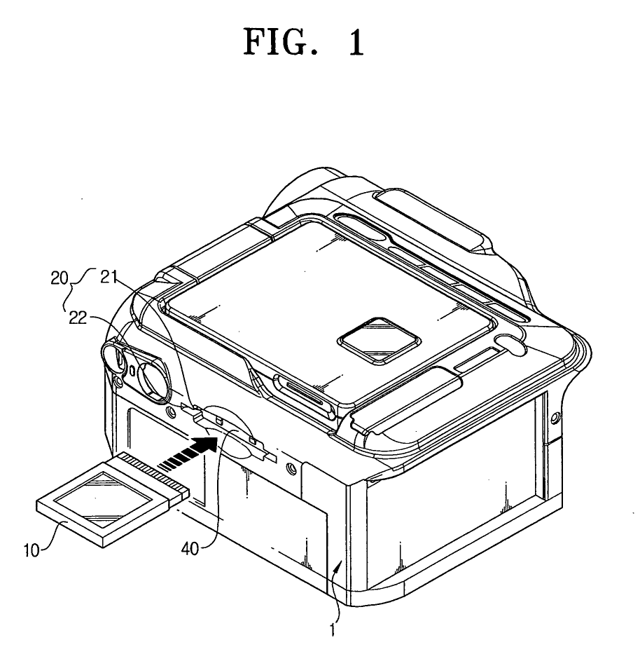

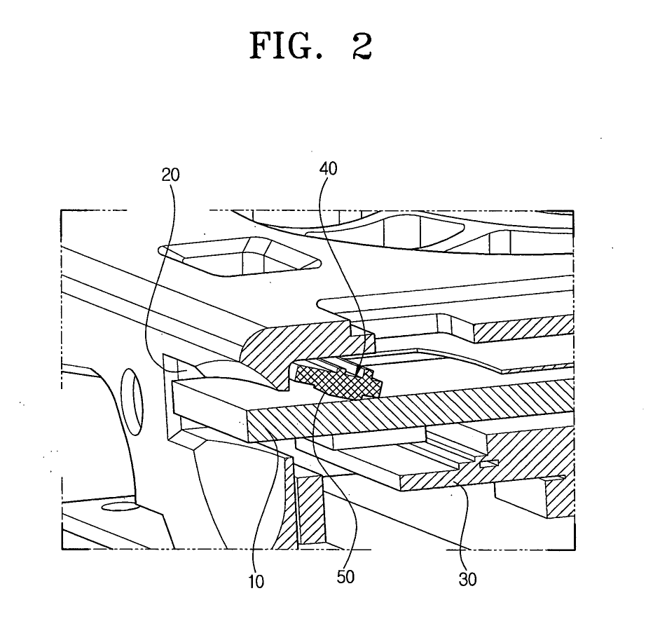

Reference number 1 of FIG. 1 is a main body of an image photographing apparatus, and reference number 10 is a memory card. Slots 20 are configured at one side of the image photographing device main body 1. The memory card 10 is inserted through the slots 20 to connect therein with a multi-card socket 30, as shown in FIG. 2.

Memory cards 10 of various thicknesses and widths, such as, inter alia, MS, SD, MMC, SM, may be used. The slots 20 may be adapted to receive the various sized memory cards 10. The first slot 21 is adapted to receive a thick and narrow memory card, such as MS cards. The second slot 22 is adapted to receive a thin and wide memory card, such as SD cards.

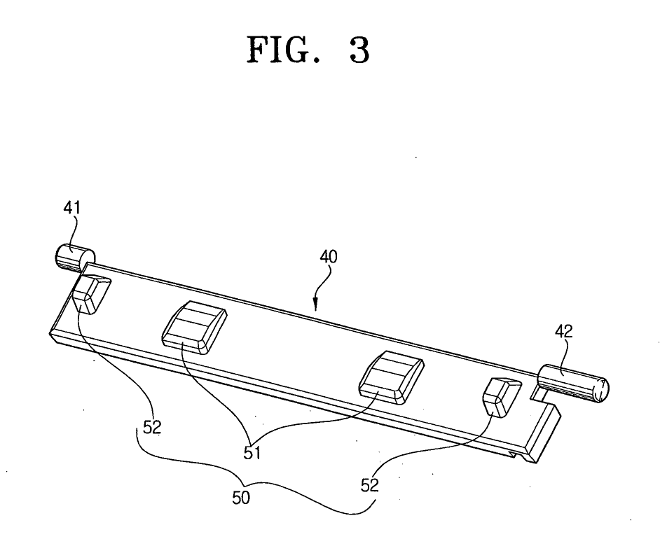

A door 40 is rotatably disposed at the entrance of the slots 20 to selectively open the slots 20. The door 40 may be turned into the slots 20 by a pair of hinges 41 and 42 (refer to FIG. 3) disposed at both end sides of the door. Normally, when an external force is not being applied to the door, the door is elastically biased in the direction of closing the entrance of the slot 20. An elastic member elastically biasing the door is not indicated, but may be formed by a spring pin of the hinges.

The door 40 has at least one friction pad 50 to hold a memory card by friction to substantially prevent the memory card 10 from moving out of the slot 20 by small shocks during use, in addition to facilitating opening and closing the entrance of the slot 20 according to an embodiment of the present invention.

The friction pads 50 extend a first height from one side of the door 40, as shown in FIG. 3. A pair of the first friction pads 51 have a first height, and a pair of the second friction pads 52 having a second height larger than the first height of the first friction pads 51. The pair of second friction pads 52 are formed at a distance from the pair of first friction pads 51, with the first friction pads 51 preferably positioned therebetween.

The first friction pads 51 generate friction by contacting one side of a thick and narrow memory card 10, such as an MS card, inserted in the first slot 21. The second friction pads 52 generate friction by contacting one side of a thin and wide memory card, such as an SD card, inserted in the second slot 22.

The friction pad 50 may be integrally formed by injection molding as one body with the surface of the door 40. Alternatively, a separate friction pad 50 may be securely attached to a surface of the door 40. Preferably, a high-frictional member, such as rubber, is integrally formed as one body by double injection molding.

A door device for opening and closing a memory card slot of an image photographing apparatus according to an embodiment of the present invention is disposed at an entrance of a slot 20. Preferably, the door device is a hinged door, but any suitable door device may be used. Therefore, when a memory card is not used, the door closes a slot 20 such that foreign substances are substantially prevented from entering the slot 20.

When a memory card 10 is pushed into the slot 20, the door 40 is rotated inwardly and then the memory card 10 is inserted in the slot 20. The memory card 10 inserted in the slot 20 is connected with a multi-card socket of the slot 20.

The door 40 rotated inwardly by the insertion of the memory card 10 is subjected to a reverse (outward) rotation force by an elastic member elastically biasing the door, thereby causing the door to contact a surface of the memory card 10. The friction pad 50 is frictionally contacted by the surface of the memory card 10, thereby holding the memory card 10 in position.

Frictional force by the friction pad 50 is applied to the memory card 10 of the slot 20 in addition to the engaging force between the memory card and the multi-card socket, thereby stably mounting the memory card 10 to prevent the memory card 10 from being easily separated from the slot 20 by small shocks during use of an image photographing apparatus.

Two pairs of friction pads 51 and 52 having different heights are mounted with the door 40 and spaced apart, thereby being adapted to not only receive a thick and narrow memory card, such as an MS card, but also a thin and wide memory card, such as an SD card, with the friction force being applied to the memory card with a substantially uniform pressure.

As described above, when various sized memory cards are used as an assistant recording media, a door frictionally holds a memory card inserted in a slot, and therefore, a memory card may be prevented from moving out of the normal position during use.

An error, such as an image information recording error, which may occur as a memory card is separated from a slot while an image photographing apparatus is used, may be prevented, thereby increasing consumer satisfaction.

Additional advantages, objects, and features of the embodiments of the invention will be set forth in part in the description which follows and in part will become apparent to those having ordinary skill in the art upon examination of the following, or may be learned from practice of the invention. The objects and advantages of the embodiments of the invention may be realized and attained as particularly pointed out in the appended claims.

1. A door device to open and close a memory card slot of an image photographing apparatus, comprising:
a door rotatably disposed at an entrance of the memory card slot to open and close the slot, the door being elastically biased in the direction of closing the slot entrance; and
at least one first friction pad on the door adapted to frictionally hold a memory card inserted in the slot.

2. The door device according to claim 1, wherein
a pair of the first friction pads are formed on the door and spaced apart.

3. The door device according to claim 1, wherein
a pair of the first friction pads having a first height are spaced apart on the door; and
a pair of the second friction pads having a second height larger than the first height of the pair of the first friction pads are spaced apart from the pair of the first friction pads on the door.

4. The door device according to claim 3, wherein
the pair of the first friction pads are positioned between the pair of the second friction pads.

5. The door device according to claim 1, wherein
the at least one friction pad is integrally formed with the door.

6. The door device according to claim 3, wherein
the pair of the first friction pads and the pair of the second friction pads are integrally formed with the door.

7. The door device according to claim 3, wherein
the pair of the first friction pads have a first width larger than a second width of the pair of the second friction pads.

8. The door device according to claim 1, wherein
the door closes the memory card slot in a first position when a memory card is not inserted in the slot, and the door rotates inwardly to a second position to frictionally engage the memory card inserted in the slot.

9. The door device according to claim 6, wherein
the pairs of the first and second friction pads and the door are made of rubber.

10. The door device according to claim 3, wherein
the pairs of the first and second friction pads are spaced to accommodate various sized memory cards.

11. A method of opening and closing a memory card slot of an image photographing apparatus, comprising the steps of
inserting a memory card into the memory card slot;
rotating a door covering the memory card slot with the memory card;
engaging the memory card with a socket disposed in the slot; and
contacting the memory card with at least one friction pad on the door to frictionally secure the memory card within the slot.

12. The method of opening and closing a memory card slot of an image photographing apparatus of claim 11, further comprising
elastically biasing the door toward the inserted memory card.

13. The method of opening and closing a memory card slot of an image photographing apparatus of claim 12, further comprising
elastically biasing the door toward a closed position when the memory card is removed from the slot.
